(19) United States
(12) Patent Application Publication
(10) Pub. No.: US 2014/0340405 A1
(43) Pub. Date: Nov. 20, 2014

(54) CROWD MOVEMENT PREDICTION USING OPTICAL FLOW ALGORITHM

(71) Applicant: International Business Machines Corporation, Armonk, NY (US)

(72) Inventors: Tiago N. dos Santos, Araraquara (BR); Rafael C. S. Folco, Santa Barbara d'Oeste (BR); Breno H. Leitao, Araraquara (BR)

(73) Assignee: International Business Machines Corporation, Armonk, NY (US)

(21) Appl. No.: 13/894,458

(22) Filed: May 15, 2013

(51) Int. Cl. G06T 11/20

(52) U.S. Cl. CPC G06T 11/20
USPC 345/440

(57) ABSTRACT

The geographical distribution of “crowdable” objects (for example, people with cell phones) is predicted in the form of a pixelated predictive map. The predictive map is based upon an optical flow algorithm, as applied to two, or more, pixelated crowdable object distribution maps, respectively representing distribution at different points in time.

### FIELD OF THE INVENTION

The present invention relates generally to the field of prediction of crowd movement, and more particularly to software-based methods and systems for predicting crowd movement.

### BACKGROUND OF THE INVENTION

For purposes of this document, a “crowd” is defined as a higher than normal concentration of some type of like objects over some range of geographical locations. Often the objects are humans, but many other objects may be part of a “crowd,” such as, to name just a few random examples: motor vehicles (whether occupied by human(s) or not); a certain type of human (for example, bicyclists riding bicycles); frogs; bars of gold; pieces of litter; trees; etc. “Crowds” do not need to be capable of movement, although many crowds are capable of movement and the movement of crowds is known to be a subject of potential interest. The use of the word “crowd” in this document should not be taken to imply any positive or negative qualities, such as unhealthy crowding, overcrowding, extra-capacity crowding, a subjective feeling of crowdedness by constituent objects of the crowd, etc.

Optical flow is the pattern of apparent motion of objects, surfaces and/or edges (collectively “visual features”) in a visual scene caused by the relative motion between an observer and the visual features. If the observer is not moving then the pattern of apparent motion will be the pattern of apparent motion of the visual features. The concept of optical flow has been used to help describe behavior of people and/or other animals that is based, at least in part, on visual stimuli. Roboticists use optical flow techniques for image processing and control of navigation. Optical flow techniques include: motion detection, object segmentation, time-to-contact information, focus of expansion calculations, luminance, motion compensated encoding, and stereo disparity measurement. Sequences of ordered images allow the estimation of motion as: (i) instantaneous image velocities; or (ii) discrete image displacements. One conventional optical flow technique is gradient based optical flow.

Optical flow methods usually try to calculate the motion between two image frames which are taken at two successive instants of time for every volumetric pixel. These methods are differential because they are usually based on local Taylor series approximations of the image signal, and because they use partial derivatives with respect to the spatial and temporal coordinates.

In computer vision, the Lucas-Kanade optical flow algorithm is a currently conventional differential method for optical flow estimation. The Lucas-Kanade algorithm: (i) assumes that the flow is essentially constant in a local neighborhood of the pixel under consideration; and (ii) under that assumption, solves the basic optical flow equations for all the pixels in that neighborhood by a least squares criterion. By combining information from several nearby pixels, the Lucas-Kanade algorithm: (i) can often resolve the inherent ambiguity of optical flow equations; (ii) is less sensitive to image noise than point-wise methods; and (iii) will not provide flow information in the interior of uniform regions of the image (because it is a purely local method).

### SUMMARY

According to an aspect of the present invention, there is a method for making a predictive map of a distribution of objects of interest (OOIs). The method includes the following steps (not necessarily in the following order): (i) providing a set of at least two input maps; and (ii) generating the predictive map based, at least in part, upon the set of input maps. Each map of the set of input maps: (i) is pixelated, (ii) represents distribution of the OOIs by associating a numerical pixel value with each pixel, and (iii) represents distribution of the OOIs at a different point in time. The predictive map: (i) is pixelated, and (ii) represents a predicted distribution of the OOIs by associating a numerical pixel value with each pixel. At least the generating step performed by computer software running on computer hardware.

### BRIEF DESCRIPTION OF THE SEVERAL VIEWS OF THE DRAWINGS

FIG. 1 is a schematic view of a first embodiment of a computer system (that is, a system including one or more processing devices) according to the present invention;

FIG. 2 is a schematic view of a computer sub-system (that is, a part of the computer system that itself includes a processing device) portion of the first embodiment computer system;

FIG. 3 is a flowchart showing a process performed, at least in part, by the first embodiment computer system;

FIG. 4 is a schematic view of a portion of the first embodiment computer system;

FIG. 5 is a first screenshot generated by the first embodiment computer system;

FIG. 6 is a second screenshot generated by the first embodiment computer system;

FIG. 7 is a third screenshot generated by the first embodiment computer system;

FIG. 8 is a fourth screenshot generated by the first embodiment computer system;

FIG. 9 is a fifth screenshot generated by the first embodiment computer system; and

FIG. 10 is a sixth screenshot generated by the first embodiment computer system.

### DETAILED DESCRIPTION

This DETAILED DESCRIPTION section will be divided into the following sub-sections: (i) The Hardware and Software Environment; (ii) Operation of Embodiment(s) of the Present Invention; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

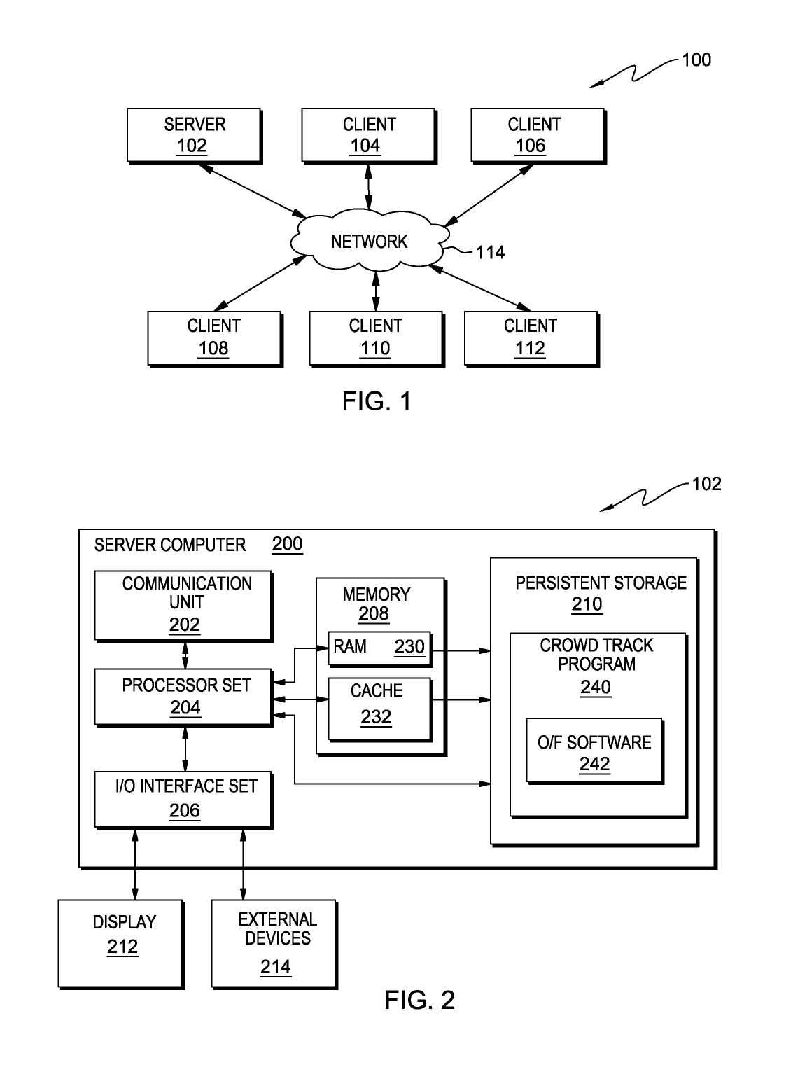

An embodiment of a possible hardware and software environment for software and/or methods according to the present invention will now be described in detail with reference to the Figures. FIGS. 1 and 2 collectively make up a functional block diagram illustrating various portions of distributed data processing system 100, including: server computer sub-system (that is, a portion of the larger computer system that itself includes a computer) 102; client computer sub-systems 104, 106, 108, 110, 112; communication network 114; server computer 200; communication unit 202; processor set 204; input/output (i/o) unit 206; memory device 208; persistent storage device 210; display device 212; external device set 214; random access memory (RAM) devices 230; cache memory device 232; crowd tracking program 240; and messages optical flow software 242.

As shown in FIG. 2, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 240 (including optical flow software 242) is a representative piece of software, and is a collection of machine readable instructions and data that is used to create, manage and control certain software functions that will be discussed in detail, below, in the Operation Of the Embodiment(s) sub-section of this DETAILED DESCRIPTION section.

Server computer sub-system 102 is capable of communicating with other computer sub-systems via network 114 (see FIG. 1). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1 and 2, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 2, server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 240 is in many respects representative of the various software modules of the present invention and is stored in persistent storage 210 for access and/or execution by one or more of the respective computer processors 204, usually through one or more memories of memory 208. Persistent storage 210 is at least more persistent than a signal in transit is, but the persistent storage may, of course, be substantially less persistent than permanent storage. Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server computer 200. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Operation of Embodiment(s) of the Present Invention

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

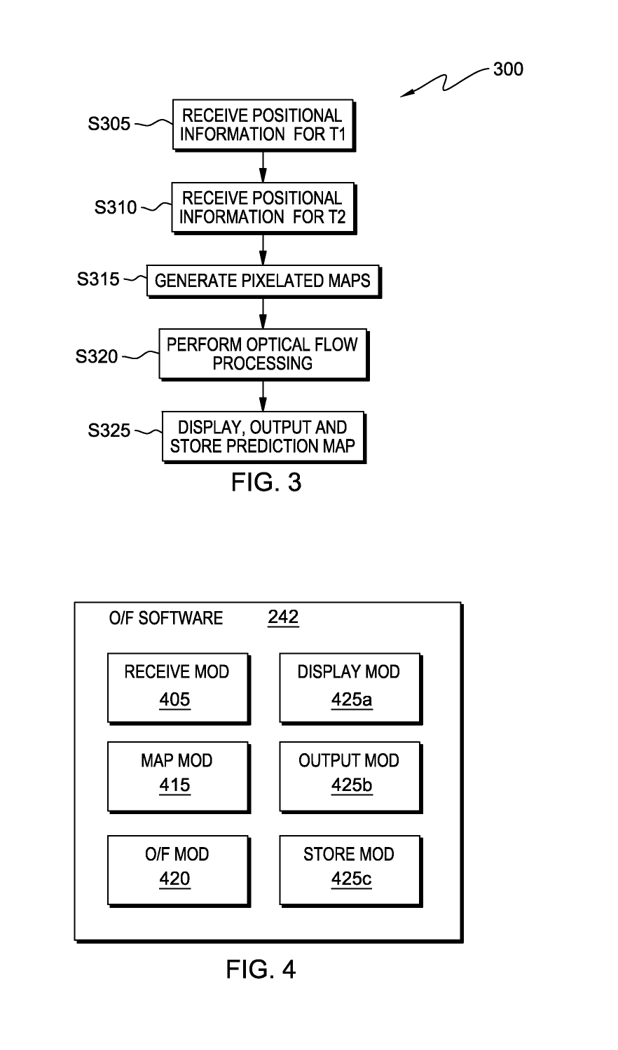

FIG. 3 shows a flow chart 300 depicting a method according to the present invention. FIG. 4 shows optical flow software 242 for performing at least some of the method steps of flow chart 300. This method and associated software will now be discussed, over the course of the following paragraphs, with extensive reference to FIG. 3 (for the method step blocks) and FIG. 4 (for the software blocks).

Processing starts at step S305 where receive module (mod) 405 receives a first set of positional information from multiple (usually a great multiplicity) crowdable objects at some time T1. In this embodiment, the crowdable objects are people carrying GPS-equipped phones, whether they are on foot, on bicycles or in motor vehicles. In this embodiment, the positional data is received substantially in real time. In alternative embodiments, the positional information may come in other ways, such as estimates based on traffic camera observation. The positional information may be an estimate based on a combination of density measurement and/or density estimation techniques (now known or to be developed in the future).

Processing proceeds to step S310 where receive mod 405 receives a second set of positional information from multiple (usually a great multiplicity) crowdable objects at some time T2.

Processing proceeds to step S315 where map mod 415 generates two pixelated maps as follows: (i) one map for T1; and (ii) one map for T2. Alternatively, more than two maps may be generated for the predictive analysis. In this embodiment, the map is two dimensional, but three dimensional pixelated maps are also possible.

In order to be considered as a “pixelated map,” a representation of a geographic area must be divided into “pixels” (also may be called “cells”). In this embodiment, the pixels are square and laid out according to a familiar Cartesian type grid. Alternatively, the pixels may have other shapes and sizes, such as a circular grid where positions are characterized by radial distance from an origin and angular offset from some predetermined zero angle. Alternatively, the pixels may be irregular. In most practical embodiments, there must a relatively large number of pixels in the pixelated maps in order for meaningful predictive analysis to occur.

In this embodiment, each pixel will have some integer value associated with it, with the integer being a measurement and/or estimation of how many people are present within the geographical area corresponding to the pixel. In other words, in this embodiment, pixel values are not limited to one and zero.

Processing proceeds to step S320 where optical flow mod processes data corresponding to the two (or more) pixelated maps in order to determine a predictive pixelated map. In this embodiment, the processing: (i) is, or includes, some “optical flow algorithm;” and (ii) uses differentials. The predictive pixelated map represents a prediction of crowd object distribution over the geographical area of the pixelated map at some point of time later than T2. In this embodiment, the prediction relates to a future time with respect to the time at which the predictive map is generated by optical flow mod 420. Alternatively, the “predictive” map may be generated “after the fact”—for example, this may occur if diagnostics and checks are being applied to the optical flow algorithm using historical crowd movement for which good distribution data exists and is pixelated.

Processing proceeds to step S325 where: (i) display mod 425a displays the predictive map; (ii) output mod 425b sends out the predictive map to recipients by email; and (iii) store mod 425c stores machine readable data corresponding to the predictive map.

III. Further Comments and/or Embodiments

Portions of the populations of cities are known to frequently locate in areas of concentration. This can happen in many ways such as the following: (i) on a daily basis, as when people go from home to an education center or work place; or (ii) when some specific event happens, like a game or a conference. The movement of the mass of people may require some action to be taken by the authorities in order to prevent, minimize and/or resolve concentration-related problems and guarantee people's security, transportation and health. Some embodiments of the present invention add an automated method to predict the movement of the masses. Using these predictions, the city authorities and business owners can be better prepared for, and/or implement quicker reactions to, the movement.

At least some embodiments of the present invention go beyond the technique of utilizing people's respective mobile phones in order to track crowd movement. Some embodiments of the present invention include one or more of the following features: (i) motion estimation of the mass (as a mass); and/or (ii) the application of the movement tracking to resolve common problems found in the big cities. Some embodiments of the present invention have one or more of the following features and/or characteristics: (i) applicable to problems with security, transportation and healthy; (ii) crowd prediction; and/or (iii) automated decisions to be taken based, at least in part, on crowd prediction.

Some embodiments of the present invention provide a method to track and predict the movement of the mass by: (i) using sequential snapshots of communication devices' positions (such as mobile phones, GPS or radio), from time to time; (ii) comparing the snapshots; and (iii) taking conclusions about the masses' movement in an automated way. Some embodiments of the present invention are independent of communication type and can benefit government authorities in the security, health, and transport/traffic areas. Some embodiments of the present invention may have one or more of the following features, advantages and/or characteristics: (i) predict and track people's movement/directions based, at least in part, on an image processing algorithm; (ii) locate concentration of people based, at least in part, on an image processing algorithm.

The history of sequential snapshots provides the movement trend in normal workdays, weekends and also on non-typical days when a special event happens. This permits the authorities to respond to pertinent questions such as the following: (i) where people are going to?; (ii) where people are going to concentrate/stand?; (iii) which areas within the city currently have a higher than normal concentration of people?; (iv) in which directions do groups of people leave from a big event (like a soccer game)?; (v) what time of the day a specific region of the city has more concentration of people?; and/or (vi) what is the trend of movement in a certain area for a specific time?

With answers to these sorts of questions, the authorities can make decisions and take actions such as the following: (i) increase police coverage and patrol; (ii) transfer emergency units to other areas (health rescue, fireman, police); (iii) traffic agents may increase number of lanes in a certain direction to improve the traffic flow; (iv) public transportations (train/bus) may quickly change operations according to the current needs of each area; (v) execute an intelligent evacuation of people from an event (for example, stadium) by changing traffic flows, train's and police operations; and/or (vi) take quick reactions for rainstorms, flooding and natural disasters (earthquakes, hurricanes, volcano).

Some embodiments of the present invention use the following method: (i) track and predict the movement of the mass by using sequential snapshots of communication devices' positions (such as mobile phones, GPS or radio), from time to time; (ii) compare the sequential snapshots; and (iii) make conclusions about the masses' movement in an automated way based, at least in part on the comparison of the sequential snapshots. In some variations, the method is independent of communication type and can benefit government authorities in the security, health, and transport/traffic areas. In some embodiments, the use of an image processing algorithm is used to help do one or more of the following: (i) track at least one aspect (for example, speed, direction, magnitude) of crowd movement; and/or (ii) predict at least one aspect (for example, speed, direction, magnitude) of crowd movement.

In some embodiments of the present invention, individuals are located via cell phones, GPS, or any communication device that allows such location. It is noted that local laws should be followed in making these locations of the involved individuals. For example, some jurisdictions may allow such tracking by the government. In other jurisdictions, individuals may consent to such tracking, especially if the individual is tracked in a manner that does not allow the tracked individual's identity to be determined. Many different communication types (now known or to be developed in the future) may be used, and, accordingly, communication type is just considered as a layer in this method for identifying movement of mass. Preferred embodiments of this method respect potential privacy concerns by sending current positions anonymously.

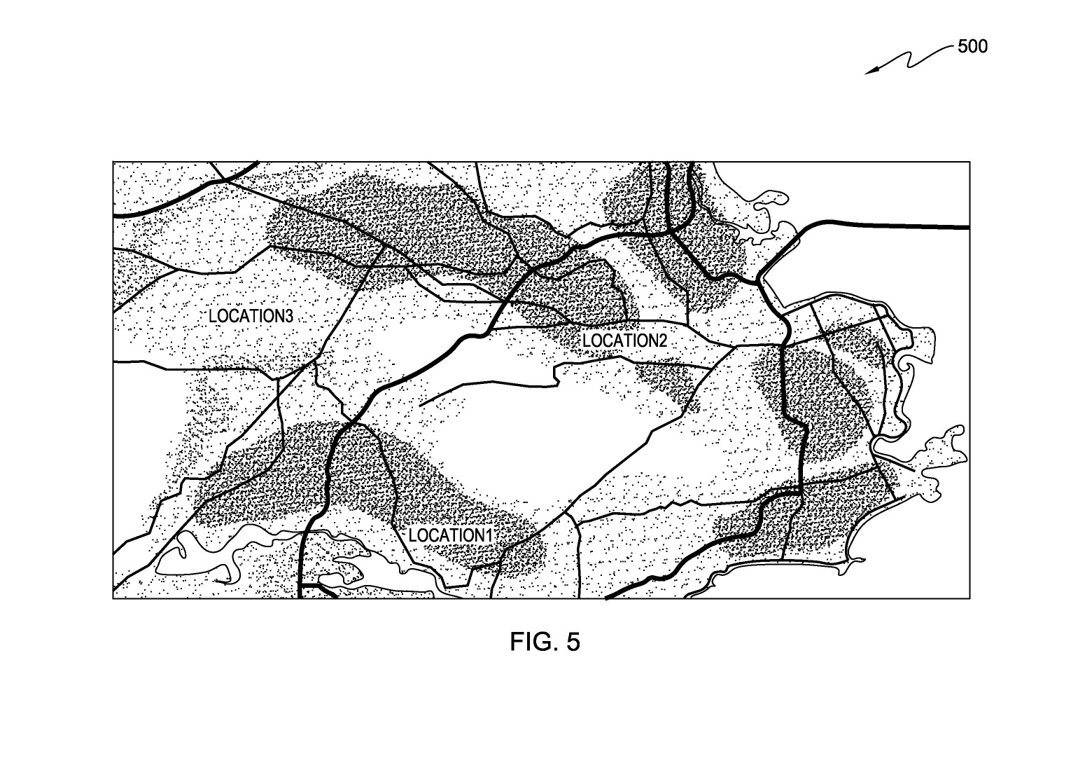

As shown in FIG. 5, snapshot 500 shows the current positions sent by people's devices by using different shades of gray. The communication devices send in, on a regular basis, the exact location (or approximate position depending on the technology used). The technologies that may be used to communicate these positional signals include the following: cellular, satellite, radio, etc.

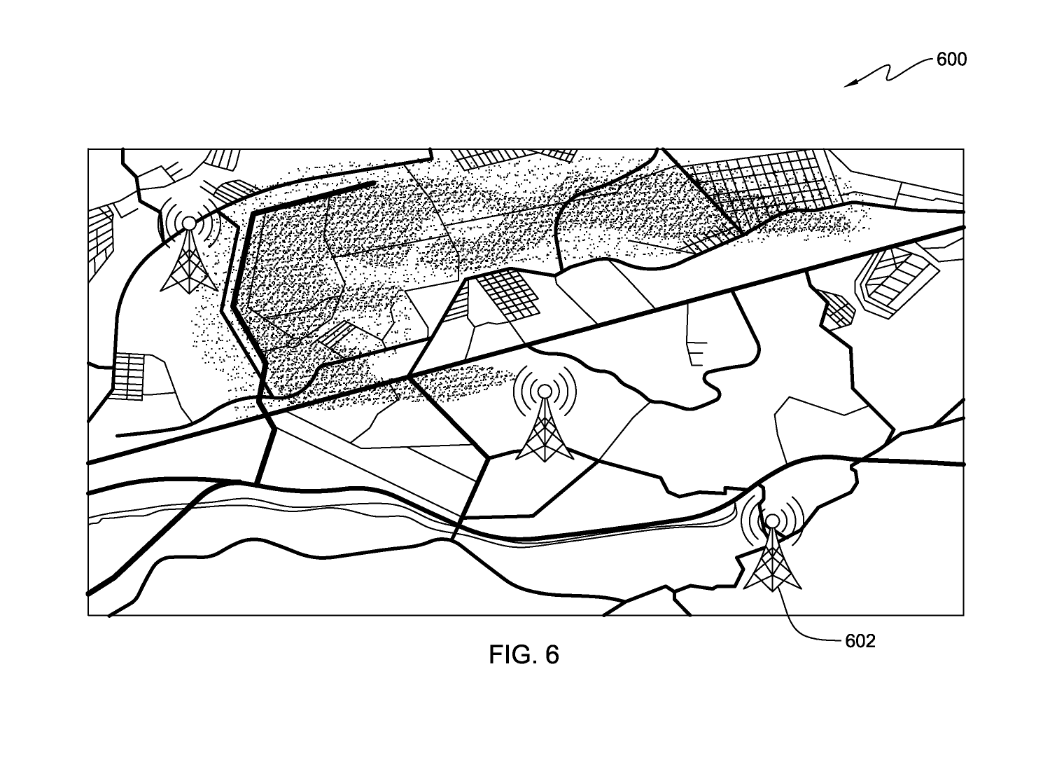

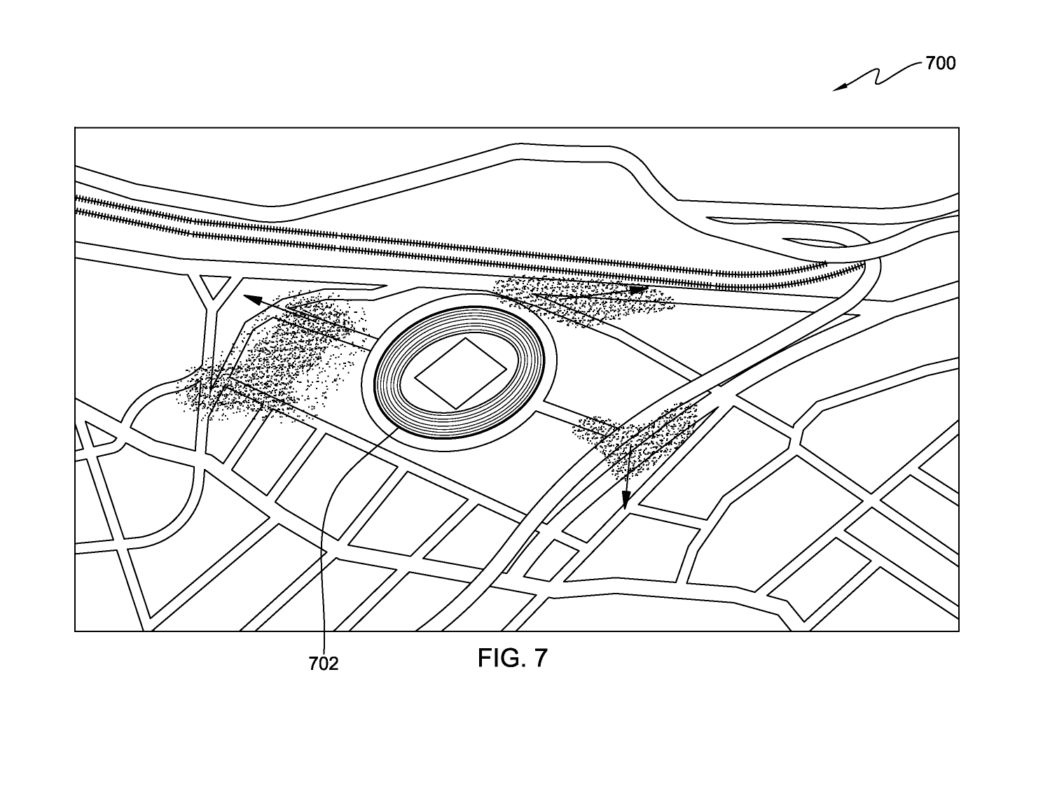

As shown in FIG. 6, antennas 602 can be used to collect the positional information wirelessly from people's transmitting devices (for example, smart phones). The information of the locations is collected from the antennas and sent to an operation center (not shown) that processes the data. This use of halftones, colors, patterns, or the like, to show crowd concentration is herein referred to as a “heatmap.” The heatmap chart of snapshot 600 is generated with people's current locations, although it should be understood that, in many embodiments, people's positional information will not be transmitted at the exact same instant, but merely close enough in time to yield a useful heatmap. How mutually close in time all the positional transmissions should be in order to generate a useful heatmap may depend upon the velocity of the subjects of a crowd.

A sequence of snapshots (or equivalent machine readable data) is required by the software in order to automatically determine a movement trend of the masses. In some embodiments, an image processing algorithm is included in the software, and is used: (i) to extract the information from the heatmap charts (or equivalent machine readable data); and (ii) based on this trend, make the predictions regarding where the mass will be moving to.

In computer vision, the Lucas-Kanade method is a widely used differential method for optical flow estimation, and this is one image processing algorithm that can be used in the present invention. It assumes that the flow is essentially constant in a local neighborhood of the pixel under consideration, and solves the basic optical flow equations for all the pixels in that neighborhood, by a least squares criterion, as will be understood by those of skill in the art. Some embodiments may use more than one image processing algorithm, either alternatively (depending upon system-wide conditions), or in combination (a prediction based on a weighted average of results from various algorithms).

As shown in FIG. 7, snapshot 700 shows a simplified view of the mass movement after a big event like a soccer game held at stadium 702. This snapshot shows three (3) crowds.

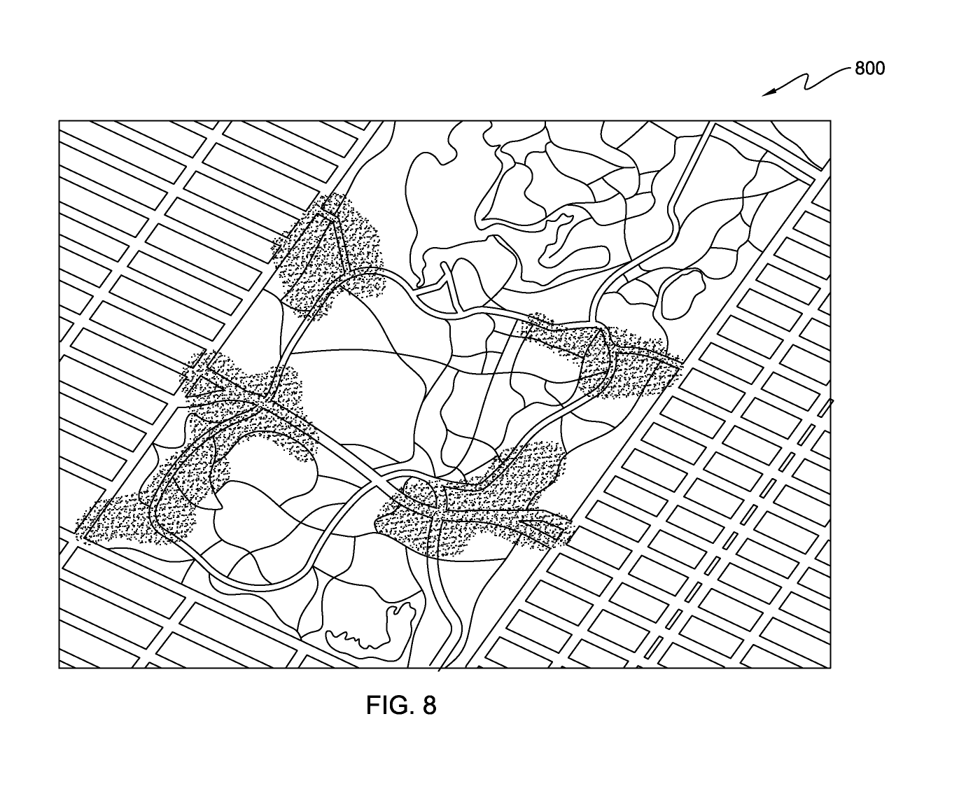

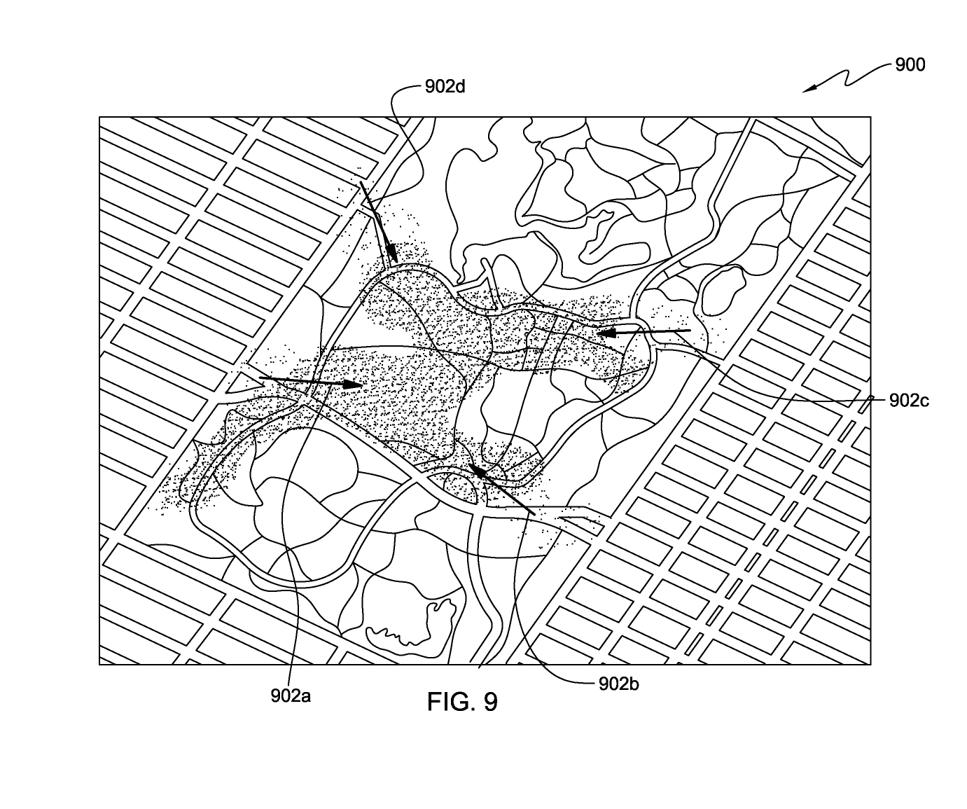

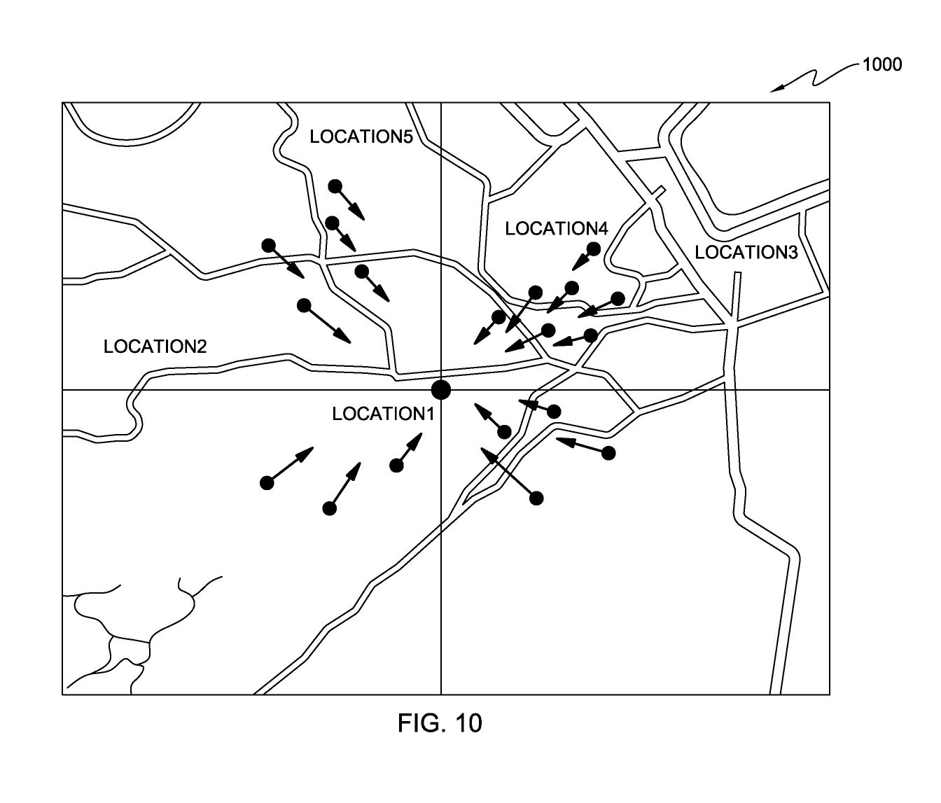

As shown in FIGS. 8 and 9, sequence of snapshots 800, 900 indicates where the mass is moving to in order to allow a prediction of: (i) future crowd position; and/or (ii) future crowd velocity. With software according to some embodiments of the present invention, it is possible to calculate estimated velocity and direction of the movement. A vector flow is predicted through the offset between two images and indicates the direction and velocity of the movement, as shown in snapshot 900 at vector arrows 902a, b, c and d. The snapshots of people's locations and also the prediction of masses' direction serve as an input to take actions in an automated way. This also helps authorities to predict and avoid “crowd collision”, as shown in snapshot 1000 of FIG. 10.

Some embodiments of the present invention may have one or more of the following features, advantages and/or characteristics: (i) good scalability for real-time processing and prediction due to use of image processing (efficient and scalable); and/or (ii) goes beyond crowd size determination to predict the direction of people in large scale.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”
and/or: non-exclusive or; for example, A and/or B means that: (i) A is true and B is false; or (ii) A is false and B is true; or (iii) A and B are both true.

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

What is claimed is:

1. A method for making a predictive map of a distribution of objects of interest (OOIs), the method comprising:
providing a set of at least two input maps; and
generating the predictive map based, at least in part, upon the set of input maps;
wherein:
each map of the set of input maps: (i) is pixelated, (ii) represents distribution of the OOIs by associating a numerical pixel value with each pixel, and (iii) represents distribution of the OOIs at a different point in time;
the predictive map: (i) is pixelated, and (ii) represents a predicted distribution of the OOIs by associating a numerical pixel value with each pixel; and
at least the generating step performed by computer software running on computer hardware.

2. The method of claim 1 wherein the generating step includes the sub-step of performing an optical flow processing algorithm on the set of input maps.

3. The method of claim 2 wherein the optical processing algorithm uses differentials.

4. The method of claim 2 wherein the optical processing algorithm is a Lucas-Kanade algorithm.

5. The method of claim 2 further comprising at least one of the following steps:
communicating the predictive map to a third party;
storing the predictive map as machine readable data on a storage device; or
displaying the predictive map in human readable form.

6. The method of claim 2 wherein the set of input maps is based on signals wirelessly respectively received from a plurality of phones.

7. A computer program product for making a predictive map of a distribution of objects of interest (OOIs), the computer program product comprising software stored on a software storage device, the software comprising:
first program instructions programmed to provide a set of at least two input maps; and
second program instructions programmed to generate the predictive map based, at least in part, upon the set of input maps;
wherein:
the software is stored on a software storage device in a manner less transitory than a signal in transit.

8. The product of claim 7 wherein the second program instructions are further programmed to perform an optical flow processing algorithm on the set of input maps.

9. The product of claim 8 wherein the optical processing algorithm uses differentials.

10. The product of claim 8 wherein the optical processing algorithm is a Lucas-Kanade algorithm.

11. The product of claim 8 further comprising third program instructions programmed to do at least one of the following:
communicate the predictive map to a third party;
store the predictive map as machine readable data on a storage device; or
display the predictive map in human readable form.

12. The product of claim 8 wherein the set of input maps is based on signals wirelessly respectively received from a plurality of phones.

13. A computer system for making a predictive map of a distribution of objects of interest (OOIs), the computer system comprising:
a processor(s) set; and
a software storage device;
wherein:
the processor set is structured, located, connected and/or programmed to run software stored on the software storage device; and
the software comprises:
first program instructions programmed to provide a set of at least two input maps; and
second program instructions programmed to generate the predictive map based, at least in part, upon the set of input maps.

14. The system of claim 13 wherein the second program instructions are further programmed to perform an optical flow processing algorithm on the set of input maps.

15. The system of claim 14 wherein the optical processing algorithm uses differentials.

16. The system of claim 14 wherein the optical processing algorithm is a Lucas-Kanade algorithm.

17. The system of claim 14 wherein the software further comprises third program instructions programmed to do at least one of the following:
communicate the predictive map to a third party;
store the predictive map as machine readable data on a storage device; or
display the predictive map in human readable form.

18. The system of claim 14 wherein the set of input maps is based on signals wirelessly respectively received from a plurality of phones.
